(19) United States
(12) Patent Application Publication
(10) Pub. No.: US 2010/0211401 A1
(43) Pub. Date: Aug. 19, 2010

(54) Transportation System

(76) Inventors: David M. Williams, Juneau, AK (US); Mary T. Donlon, Juneau, AK (US)

Correspondence Address: HARSHAW RESEARCH, INC., 210 W. TECUMSEH STREET, OTTAWA, KS, 66067, US

(21) Appl. No.: 12/371,843

(22) Filed: Feb. 16, 2009

(51) Int. Cl. G06Q 99/00

(52) U.S. Cl. 705/1.1

(57) ABSTRACT

A transportation system includes a main server, a plurality of driver communication units remote from the main server, and a plurality of request communication units remote from the main server. Each driver unit includes a GPS receiver and each driver and request unit include a connection to the server. The main server includes instructions to cause a security screening to be conducted in response to a membership request and then to accept the requests. The server or respective driver communication unit includes instructions to map a destination route and display the mapped destination route on the respective driver communication unit output upon entry of a destination by a member driver. Further instructions on the main server match at least one the transportation request with the mapped destination route.

### BACKGROUND OF THE INVENTION

This invention relates generally to transportation systems and, more particularly, to a system for matching persons who desire to participate as riders in a carpool with willing drivers who have posted a destination and route matching respective rider destinations.

Commuting to and from work on a daily basis is often a frustrating part of life, partly because of overcrowded roadways and partly because of the expense of maintaining a vehicle and the high price of gasoline. One option to the personal commute is to use public transportation, such as bus, train, or subway systems. However, public transportation may not always be a desirable or feasible option, especially for persons who live a distance from a pickup point or if the length and route of the public transportation system is considered too long, inefficient, or even unsafe.

Another commuting option has grown in popularity in recent years. More particularly, many commuters have chosen to “carpool”—meaning that multiple commuters choose to ride to work together in the same personal vehicle. Typically, workers that live in close proximity to one another or that all work at the same workplace agree to share the cost of the drive to work. In some cases, the carpoolers may alternate on who drives or who supplies the vehicle. The traditional idea of carpooling, however, has also become difficult or problematic in that family, close friends, and coworkers often live further away from one another than in the past. The distance between workplaces of commuters may also make carpooling difficult.

Various methods and systems have been proposed in the art to provide carpooling to willing riders and drivers. Although assumably effective for their intended purposes, the existing systems do not maximize the safety and security to riders and drivers who, prior to being matched into a carpool, do not know each other. Further, the existing systems may not provide fast and efficient matches between a rider's desired destination and a driver's destination along with providing adequate incentives to the driver.

Therefore, it would be desirable to have a transportation system that overcomes the current limitations of existing systems and provides convenient and secure transportation to a rider on a one-time or repeated travel occasion.

### SUMMARY OF THE INVENTION

A transportation system according to the present invention includes a main server, a plurality of driver communication units remote from the main server, and a plurality of request communication units remote from the main server. Each driver unit includes a GPS receiver and each driver and request unit includes a connection to the server. The main server includes instructions to cause a security screening to be conducted in response to a membership request and then to accept the requests. The server or respective driver communication unit includes instructions to map a destination route and display the mapped destination route on the respective driver communication unit output upon entry of a destination by a member driver. Further instructions on the main server match at least one the transportation request with the mapped destination route.

Therefore, a general object of this invention is to provide a transportation system for matching persons desiring to be riders in a vehicle carpool with persons desiring to drive others in a vehicle carpool.

Another object of this invention is to provide a transportation system, as aforesaid, that screens riders for security clearance.

Yet another object of this invention is to provide a transportation system, as aforesaid, that matches rider destination requests with a driver destination submission.

Still another object of this invention is to provide a transportation system, as aforesaid, that enables a rider to submit a review to the system server following the carpool ride.

A further object of this invention is to provide a transportation system, as aforesaid, that matches riders according to personal preferences.

A still further object of this invention is to provide a transportation system, as aforesaid, that also accepts shopping requests to be fulfilled by willing drivers.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a block diagram illustrating the components of a transportation system according to a preferred embodiment of the present invention;

FIG. 2a is a perspective view of a driver communication unit;

FIG. 2b is a front view of the driver communication unit as in FIG. 2a; and

FIG. 3 is a flowchart illustrating the logic of the main server according to the system of FIG. 1.

### DESCRIPTION OF THE PREFERRED EMBODIMENT

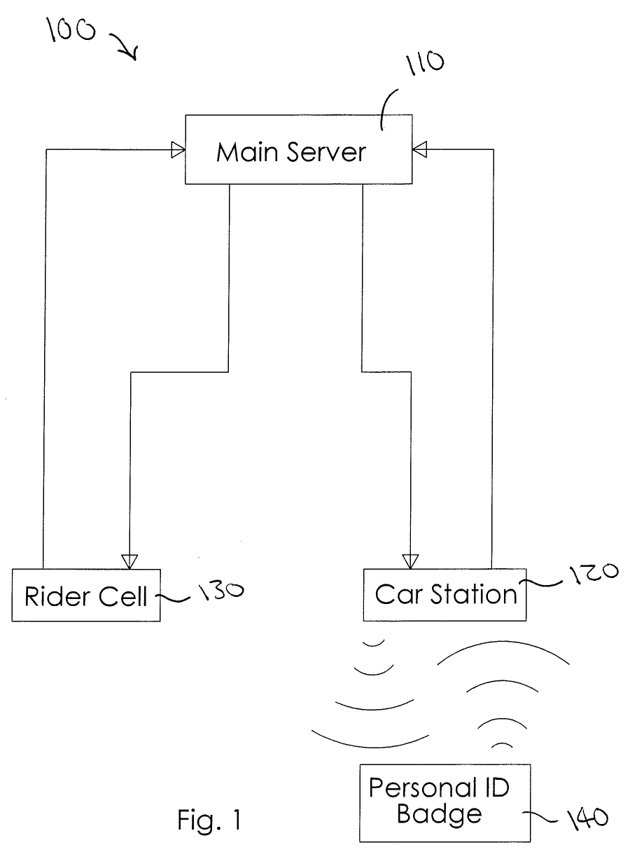

A transportation system will now be described in detail with reference to FIG. 1 through FIG. 3 of the accompanying drawings. More particularly, a transportation system 100 includes a main server 110, a plurality of driver communication units 120 remote from the main server 110, and a plurality of request communication units 130 remote from the main server 110, as shown in FIG. 1.

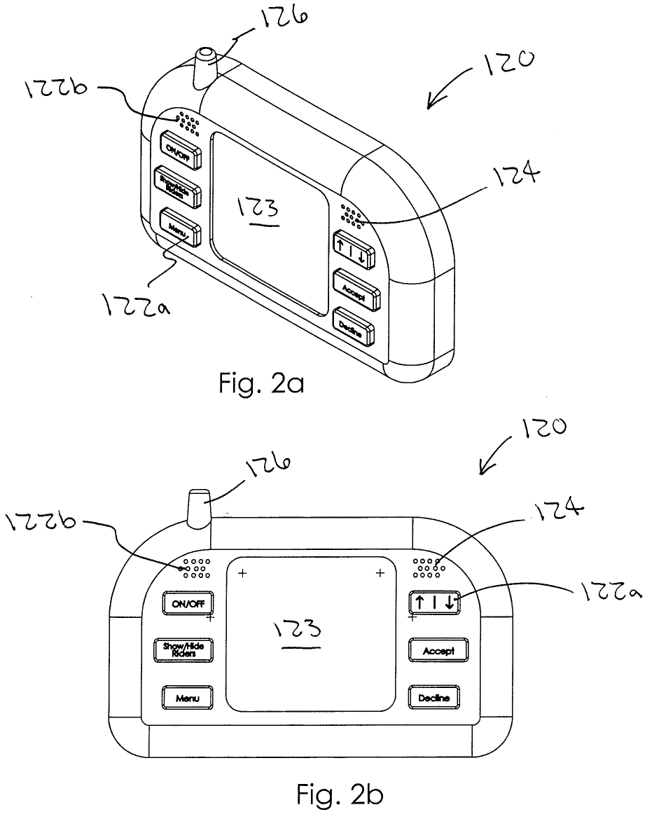

As shown in FIGS. 2a and 2b, each driver communication unit 120 may have at least one input (e.g., buttons 122a, microphone 122b, touchscreen 123, etc.), at least one output (e.g., touchscreen 123, speaker 124, etc.), a GPS receiver (not shown), and means for communicating with the main server 110. The means for communicating with the main server 110 may include various wireless communication hardware 126, such as an RF transmitter/receiver, cellular communication hardware, etc. In some embodiments, the driver communication units 120 are portable; in other embodiments, the driver communication units 120 are installed in vehicles.

Each request communication unit 130 has an input, an output, and means for communicating with the main server 110. In some embodiments, the request communication units 130 are telephones (landlines, cellular telephones, etc.) that have standard telephone inputs, outputs, and communication hardware. Other request communication units 130, for example, may be computers with communication hardware to access the main server 110 through a network (e.g., the Internet).

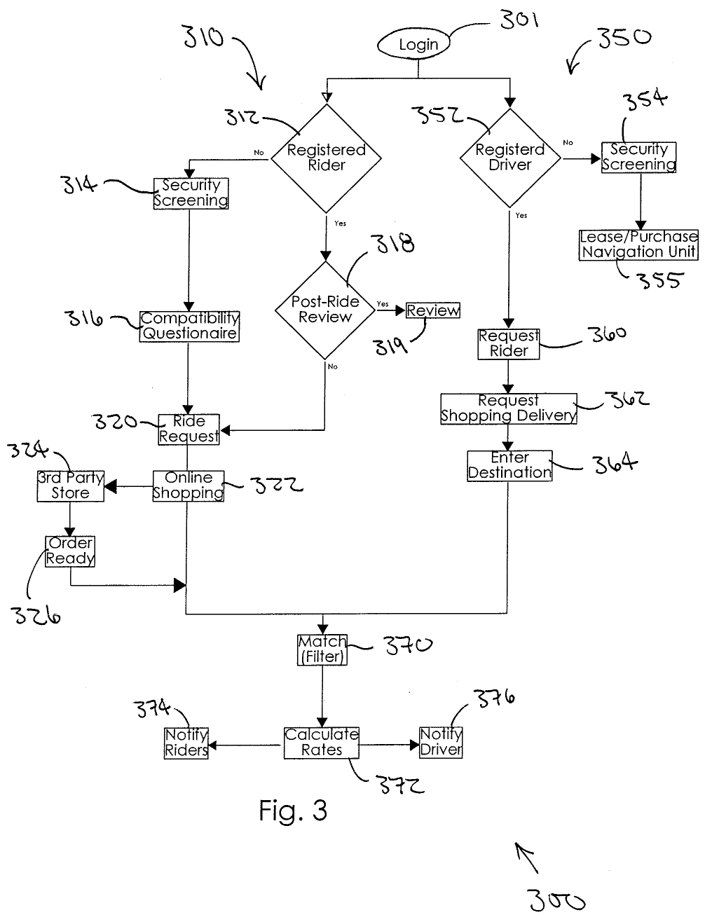

FIG. 3. illustrates various instructions (e.g., computer programming, or instructions in machine language) present in the system 100 by showing exemplary logic/steps 300 used by the system 100. It should be understood that the main server 110 may comprise multiple computers and/or that the instructions described herein may be located at various locations in the system 100 (e.g., in the main server 110, driver communication units 120, etc.,) all of which is contemplated by the current invention.

At step 301, a person accesses the main server 110 (e.g., through a respective driver communication unit 120 or a respective request communication unit 130). The main server 110 may run a rider routine 310 or a driver routine 350 based on input by the person or the device used to access the main server 110 (e.g., if a driver communication unit 120 is used to access the main server 110, the main server 110 may automatically run the driver routine 350). At step 312, the main server 110 determines if the person accessing the main server 110 is a member requester. If not, the routine 310 proceeds to step 314; if so, the routine 310 proceeds to step 318.

At step 314, instructions in the main server 110 cause a security screening to be conducted in response to the person's membership request. This may include, for example, performing or requesting a criminal record search and contacting references provided by the prospective member. The routine 310 proceeds from step 314 to step 316, where the prospective member provides personal profile information (e.g., sex, personal interests, personality traits, etc.) and the main server 110 compiles and retains the personal profile information for the prospective member. Step 316 may be performed either before or after the security screening set forth in step 314 is concluded, though the routine 310 may not proceed from step 316 until the security screening is concluded favorably and the person has been granted membership. People who have been granted membership as “riders” or “requesters” (i.e., someone requesting transportation but not driving others) are generally referred to herein as “member requesters”.

At steps 320-326 in the routine 310, instructions in the main server 110 may accept transportation requests from the member requester. For example, as shown at step 320, the member requester may request a ride; and/or as shown at steps 322-326, the member requester may request a delivery. The delivery may be for an item purchased through online shopping at third party stores accessed through the main server 110 (steps 322, 324) that lead to an order that is ready to be picked up (step 326), or the purchase may otherwise be made and the order may be ready to be picked up (step 326). Regardless of the type of transportation request, the transportation request may be entered through the input of the member requester's request communication unit 130, and the request may have geographical and temporal elements (i.e., pick-up and drop-off information and a time of when the pick-up and/or drop-off needs to occur). It should be appreciated that multiple member requesters may access the main server 110 simultaneously, and that the main server 110 may accept multiple transportation requests at any given time.

Turning to the routine 350, at step 352, the main server 110 determines if the person accessing the main server 110 is a member driver. If not, the routine 310 proceeds to step 354; if so, the routine 310 proceeds to step 360.

At step 354, instructions in the main server 110 cause a security screening to be conducted in response to the person's membership request. This may include, for example, performing or requesting a criminal record search, performing or requesting a driving record search, and contacting references provided by the prospective member. Though not shown, the routine 350 proceeds from step 354 to a step where the prospective member provides personal profile information (e.g., sex, personal interests, personality traits, etc.) and the main server 110 compiles and retains the personal profile information for the prospective member. This personal profile information may be provided either before or after the security screening set forth in step 354 is concluded, though the routine 310 may not proceed to step 360 until the security screening is concluded favorably and the person has been granted membership. People who have been granted membership as drivers (i.e., people permitted to drive others and/or make deliveries) are generally referred to herein as “member drivers”. As shown at step 355, the member drivers may obtain (by purchase, by lease, for free, etc.) the driver communication units 120 after being granted membership as drivers.

At steps 360, 362, and 364 in the routine 350, instructions in the main server 110 may accept various information from the driver communication unit 120. It should be understood that, like other steps in the logic 300, steps 360, 362, and 364 may be performed in various different orders. At steps 360 and 362, the instructions in the main server 110 accept requests from the member driver (input through the driver communication unit 120) to be matched with transportation requests (i.e., a ride request, as shown in step 360, or a delivery request, as shown in step 362). At step 364, the instructions in the main server 110 accept the member driver's destination (input through the driver communication unit 120) and current position (obtained by the GPS receiver and input through the driver communication unit 120) and map a destination route based on the member driver's destination and current position. Instead of, or in addition to, current position, a future position and time may be input. For example, the member driver's place of employment and anticipated time of departure from work may be input. The destination route may then be displayed on the driver communication unit output 123. It should be appreciated that multiple member drivers may access the main server 110 simultaneously, and that the main server 110 may accept multiple member driver requests at any given time.

After running routines 310 and 350, instructions in the main server 310 match the transportation requests with the driver requests (i.e., the mapped destination routes) at step 370. It should be understood that the main server 310 may be matching the requests while simultaneously running routines 310, 350 for additional member requesters and member drivers. Matching may be based on personal profile information of the member drivers and member requesters (e.g., some member drivers and member requesters may prefer to be matched with someone of one sex or the other,) geographical proximity of the transportation requests to the destination routes, temporal proximity of the transportation requests to the destination routes, etc.

Once the requests are matched, instructions in the main server 110 may alter the mapped destination routes to incorporate the matched transportation requests. The altered destination routes may then be displayed on the drivers' communication unit outputs 123.

As shown in steps 374 and 376, instructions in the main server 110 may notify the member riders of the match results, such as through the request communication units (step 374,) and notify the member drivers of the match results (step 376). The member drivers may be notified by the display of the altered destination routes on the driver communication units 120, for example.

As shown at step 372, money may be involved. More particularly, the member requesters may pay money (e.g., a set membership fee, a membership fee based on use, etc.) to use the transportation system 100, and the main server 110 may include instructions to distribute at least some of the money collected from the member requesters to the member drivers. The amount of money distributed to the member drivers may be based on the number of transportation requests fulfilled by the respective drivers, the amount of time that the respective member drivers spend fulfilling transportation requests, the amount of miles that the respective member drivers spend fulfilling transportation requests, etc.

As shown in FIG. 1, the transportation system 100 may include a plurality of identification devices 140 recognizable by the driver communication units 120, and each member requester may have a unique identification device 140. Communication between the identification devices 140 and the driver communication units 120 may be through RFID technology, barcode technology, or any other appropriate communication technology. To track use (e.g., for collection/distribution of money, as discussed above) and/or to ensure that only member requesters and member drivers use the transportation system 100, it may be required that member requesters identify themselves to the driver communication units 120 using the identification devices 140 for each fulfilled transportation request. Instructions in the main server 110 may track and log the interaction between identification devices 140 and driver communication units 120.

Returning to step 318 in the routine 310, instructions in the main server 110 may provide member requesters the opportunity to provide feedback following a fulfilled transportation request for the member driver that was associated with the fulfilled transportation request (i.e., the member driver that provided the ride or delivery for the member requester). If the member requester accepts the opportunity to provide feedback by proceeding to step 319, instructions in the main server 110 may collect feedback from the member requester (e.g., feedback regarding safety, timeliness, cleanliness, politeness, etc.) and update the profile information for the respective member driver. The updated profile information may then be used in future matching operations.

Similarly, though not shown in FIG. 3, the routine 350 may allow the member drivers to provide feedback following fulfilled transportation requests for the member requester that was associated with the fulfilled transportation request (i.e., the member requester that was given the ride or delivery by the member driver). Instructions in the main server 110 may collect feedback from the member driver (e.g., feedback regarding timeliness, cleanliness, politeness, etc.) and update the profile information for the respective member requester. The updated profile information may then be used in future matching operations.

It is understood that while certain forms of this invention have been illustrated and described, it is not limited thereto except insofar as such limitations are included in the following claims and allowable functional equivalents thereof.

1. A transportation system, comprising:
a main server;
a plurality of driver communication units remote from said main server, respective driver communication units having an input, an output, a GPS receiver, and means for communicating with said main server;
a plurality of request communication units remote from said main server, respective request communication units having an input, an output, and means for communicating with said main server;
instructions in said main server to cause a security screening to be conducted in response to a membership request;
instructions in said main server to accept transportation requests from member requesters, said transportation requests being entered through said request communication unit inputs;
instructions in at least one of said main server and a respective driver communication unit to map a destination route and display said mapped destination route on said respective driver communication unit output upon entry of a destination by a member driver through said respective driver communication unit input;
instructions in said main server to match at least one said transportation request with said mapped destination route;
instructions in at least one of said main server and said respective driver communication unit to alter said mapped destination route to incorporate said at least one transportation request matched with said mapped destination route and display said altered destination route on said respective driver communication unit output.

2. The system of claim 1, wherein:
said member requesters pay money; and
said main server includes instructions to distribute at least some said money collected from said member requesters to said member driver.

3. The system of claim 2, further comprising instructions in said main server to create an updated profile for a respective member requester based on feedback following a respective transportation request by said respective member.

4. The system of claim 3, wherein said instructions in said main server to match at least one said transportation request with said mapped destination route perform said matching based on at least one of:
(a) sex of said member driver and sex of said member requesters;
(b) geographical proximity of said transportation request to said destination route; and
(c) temporal proximity of said transportation request to said destination route.

5. The system of claim 4, wherein said security screening includes at least one of a criminal record search, a driving record search, and contacting references.

6. The system of claim 5, wherein:
said driver communication unit inputs include at least one of touchscreens and microphones;
said request communication units are selected from telephones and computers.

7. The system of claim 6, wherein said transportation requests are at least one of requests for rides and requests for deliveries.

8. The system of claim 7, further comprising a respective identification device for each said member requester, each identification device being recognizable by said driver communication units.

9. The system of claim 1, further comprising a respective identification device for each said member requester, each identification device being recognizable by said driver communication units.

10. The system of claim 1, wherein said instructions in said main server to match at least one said transportation request with said mapped destination route perform said matching based on all of:
(a) sex of said member driver and sex of said member requesters;
(b) geographical proximity of said transportation request to said destination route; and
(c) temporal proximity of said transportation request to said destination route.

11. A transportation system, comprising:
a main server;
a plurality of driver communication units remote from said main server, respective driver communication units having an input, an output, a GPS receiver, and wireless communication hardware for communicating with said main server;
a plurality of request communication units remote from said main server, respective request communication units having an input, an output, and communication hardware for communicating with said main server;
instructions in said main server to accept transportation requests from member requesters, said transportation requests being entered through said request communication unit inputs and having geographic and temporal elements;
instructions in said main server to map destination routes based on entry of destinations by member drivers through said driver communication unit inputs and data from said GPS receivers;
instructions in said main server to accept requests from member drivers and match said member driver requests with said transportation requests; and
instructions in at least one of said main server and said driver communication units to alter said mapped destination routes to incorporate said geographic elements of said matched transportation requests and display said altered destination routes on said driver communication unit outputs.

12. The system of claim 11, wherein:
said member requesters pay money; and
said main server includes instructions to distribute at least some said money collected from said member requesters to said member drivers.

13. The system of claim 12, wherein:
said main server includes personal profile information for each member driver and each member requester; and
said instructions in said main server to match said member driver requests with said transportation requests perform said matching based on at least one of:
(a) said personal profile information; and
(b) proximity of said transportation request geographic elements to said destination routes.

14. The system of claim 13, wherein said transportation requests are at least one of requests for rides and requests for deliveries.

15. The system of claim 13, further comprising instructions in said main server to accept feedback regarding said member requesters and said member drivers and update said personal profile information based on said feedback.

16. The system of claim 12, further comprising a respective identification device for each said member requester, each identification device being recognizable by said driver communication units.

17. The system of claim 11, further comprising a respective identification device for each said member requester, each identification device being recognizable by said driver communication units.

18. The system of claim 11, wherein said transportation requests are at least one of requests for rides and requests for deliveries.

19. The system of claim 11, wherein said request communication units are selected from telephones and computers.

20. The system of claim 19, wherein:
said main server includes personal profile information for each member driver and each member requester;
said instructions in said main server to match said member driver requests with said transportation requests perform said matching based on at least one of:
(a) said personal profile information; and
(b) proximity of said transportation request geographic elements to said destination routes;
said main server includes instructions to accept feedback regarding said member requesters and said member drivers and update said personal profile information based on said feedback;
each member requester has a respective identification device, each identification device being recognizable by said driver communication units;
said member requesters pay money; and
said main server includes instructions to distribute at least some said money collected from said member requesters to said member drivers.
